(19) United States
(12) Patent Application Publication
(10) Pub. No.: US 2025/0148743 A1
(43) Pub. Date: May 8, 2025

(54) IMAGE INFORMATION PROCESSING APPARATUS, IMAGE INFORMATION PROCESSING METHOD, AND NON-TRANSITORY COMPUTER READABLE MEDIUM

(71) Applicants: Rigshospitalet, Copenhagen (DK); Canon Kabushiki Kaisha, Tokyo (JP); CANON MEDICAL SYSTEMS CORPORATION, Tochigi (JP)

(72) Inventors: Klaus FUGLSANG KOFOED, Copenhagen (DK); Michael Huy Cuong PHAM, Copenhagen (DK); Yukiteru MASUDA, Kawasaki (JP); Ryo ISHIKAWA, Kawasaki (JP); Gakuto AOYAMA, Kawasaki (JP)

(73) Assignees: Rigshospitalet, Copenhagen (DK); Canon Kabushiki Kaisha, Tokyo (JP); CANON MEDICAL SYSTEMS CORPORATION, Tochigi (JP)

(21) Appl. No.: 18/938,339

(22) Filed: Nov. 6, 2024

(30) Foreign Application Priority Data
Nov. 6, 2023 (JP) 2023-189301

(51) Int. Cl. G06V 10/24; G06T 7/11; G06T 7/62; G06V 10/26

(52) U.S. Cl. CPC G06V 10/245; G06T 7/11; G06T 7/62; G06V 10/26; G06T 2207/10081; G06T 2207/20021; G06T 2207/30048; G06V 2201/031

(57) ABSTRACT

An image information processing apparatus according to an embodiment includes processing circuitry. The processing circuitry acquires a structure from a medical image, sets one or more lines or planes that divide the structure into a plurality of regions, calculates feature quantities related to a form of the structure for each of the regions, and corrects the structure so that a difference in the feature quantities is reduced.

### CROSS-REFERENCE TO RELATED APPLICATIONS

This application is based upon and claims the benefit of priority from Japanese Patent Application No. 2023-189301,filed on Nov. 6, 2023; the entire contents of which are incorporated herein by reference.

### FIELD

Embodiments disclosed herein relate generally to an image information processing apparatus, an image information processing method, and a non-transitory computer readable medium.

### BACKGROUND

When a treatment by using medical images is planned, a region of a predetermined anatomical structure (i.e. organ) is extracted from the medical image and various measurement values are calculated from the region. For example, the region of an organ can be extracted from a medical image by machine learning or the like, and various measurement values can be calculated from the extracted region.

However, in an organ segmentation process using machine learning or the like in the related art, even when, for example, an organ has left-right symmetrical anatomical feature quantities, since the left-right symmetry of the organ is not fully taken into account, results that are inconsistent with the left-right symmetry of anatomical feature quantities may be obtained. When the organ segmentation process is simply performed left-right symmetrically with respect to a reference axis and left and right data are averaged, for example, around the reference axis, the left-right symmetry of the anatomical feature quantities is maintained, but the anatomical structures concerned often differ from the actual structure.

### BRIEF DESCRIPTION OF THE DRAWINGS

FIG. 1 is a diagram illustrating an example of the configuration of an X-ray CT apparatus including an image information processing apparatus according to an embodiment;

FIG. 2 is a flowchart illustrating the flow of a process performed by an image information processing apparatus according to a first embodiment;

FIG. 3 is a diagram illustrating an example of the extraction of a target a structure of interest in the image information processing apparatus according to the first embodiment;

FIG. 4 is a diagram illustrating the setting of a reference line in the image information processing apparatus according to the first embodiment;

FIG. 5 is a diagram illustrating another example of setting a reference line in the image information processing apparatus according to the first embodiment;

FIG. 6 is a diagram illustrating the setting of correction locations in the image information processing apparatus according to the first embodiment;

FIG. 7 is a diagram illustrating the setting of correction locations in the image information processing apparatus according to the first embodiment;

FIG. 8 is a diagram explaining a correction process in the image information processing apparatus according to the first embodiment;

FIG. 9 is a diagram explaining a correction process in the image information processing apparatus according to the first embodiment;

FIG. 10 is a diagram explaining a correction process in the image information processing apparatus according to the first embodiment;

FIG. 11 is a diagram explaining a correction process in the image information processing apparatus according to the first embodiment;

FIG. 12 is a diagram explaining another example of a correction process in the image information processing apparatus according to the first embodiment;

FIG. 13 is a diagram explaining another example of a correction process in the image information processing apparatus according to the first embodiment; and

FIG. 14 is a diagram explaining examples of GUIs according to a second variation and a third variation of the first embodiment.

### DETAILED DESCRIPTION

An image information processing apparatus provided in one aspect of the present invention includes processing circuitry. The processing circuitry acquires a structure from a medical image, sets one or more lines or planes that divide the structure into a plurality of regions, calculates feature quantities related to the form of the structure for each of the regions, and corrects the structure so that the difference in the feature quantities is reduced.

Embodiments of an image information processing apparatus, an image information processing method, and a computer program are described in detail below with reference to the drawings.

### First Embodiment

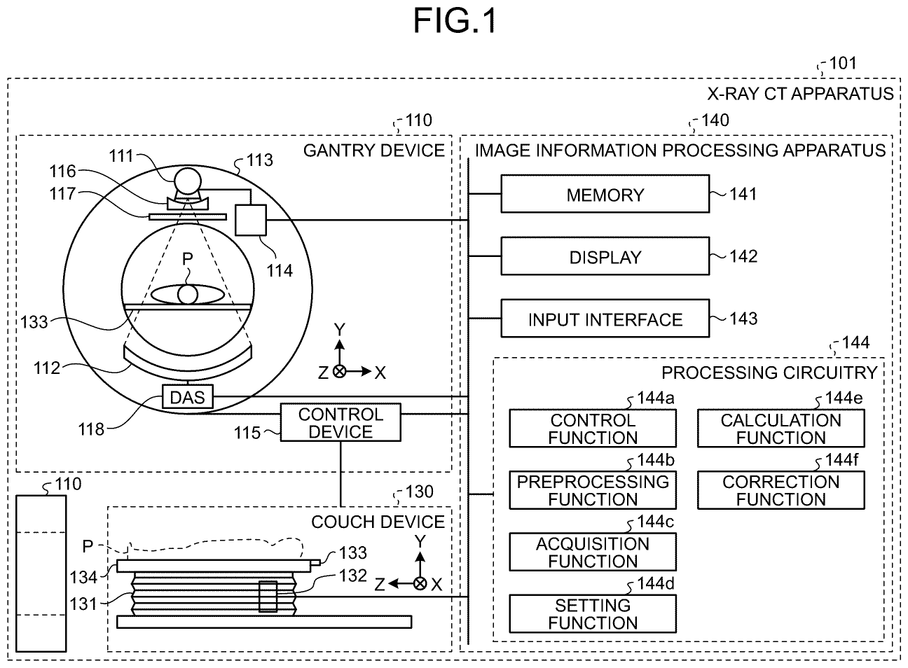

FIG. 1 illustrates an example of the configuration of an image information processing apparatus 140 according to an embodiment. In FIG. 1, a case in which the image information processing apparatus 140 according to the embodiment is a part of an X-ray CT apparatus 101 is described. The image information processing apparatus 140 is not limited to being a part of the X-ray CT apparatus 101, but may also be a part of a medical image diagnostic apparatus other than the X-ray CT apparatus such as an ultrasound diagnostic apparatus or a magnetic resonance imaging apparatus. As another example, the image information processing apparatus 140 may be configured independently of these medical image diagnostic apparatuses.

As illustrated in FIG. 1, the X-ray CT apparatus 101 according to the embodiment has a gantry device 110, a couch device 130, and the image information processing apparatus 140. FIG. 1 illustrates the gantry device 110 drawn from a plurality of directions for the purpose of explanation, and illustrates a case in which the X-ray CT apparatus 101 has one gantry device 110.

The gantry device 110 has an X-ray tube 111, an X-ray detector 112, a rotating frame 113, an X-ray high voltage device 114, a control device 115, a wedge 116, a collimator 117, and a data acquisition system (DAS) 118.

The X-ray tube 111 is a vacuum tube with a cathode (filament) that generates hot electrons and an anode (target) that generates X-rays upon impact of the hot electrons. The X-ray tube 111 generates X-rays that are emitted to a subject P by hot electrons from the cathode to the anode due to the application of high voltage from the X-ray high voltage device 114. For example, the X-ray tube 111 is a rotating anode X-ray tube that generates X-rays by emitting hot electrons to a rotating anode.

The X-ray tube 111 and the control device 115 are an example of an x-ray irradiation unit. The x-ray irradiation unit performs a low-flux scan on a phantom made of known material and having transmission length. Specifically, the x-ray irradiation unit performs a low-flux scan by performing an air scan and a scan on a phantom made of a plurality of different materials at the initial current intensity and respective tube voltage settings of the X-ray tube.

The rotating frame 113 is an annular frame that supports the X-ray tube 111 and the X-ray detector 112 opposite each other and rotates the X-ray tube 111 and the X-ray detector 112 by using the control device 115. For example, the rotating frame 113 is a casting made of aluminum. In addition to the X-ray tube 111 and the X-ray detector 112, the rotating frame 113 can further support the X-ray high voltage device 114, the wedge 116, the collimator 117, the DAS 118, and the like. Moreover, the rotating frame 113 can further support various configurations not illustrated in FIG. 1.

The wedge 116 is a filter used to regulate the x-ray dose emitted from the X-ray tube 111. Specifically, the wedge 116 is a filter that transmits and attenuates X-rays emitted from the X-ray tube 111 so that the distribution of the X-rays emitted from the X-ray tube 111 to the subject P is a predetermined distribution. For example, the wedge 116 is a wedge filter or a bow-tie filter, and is a filter made of aluminum or other material processed to have a predetermined target angle and a predetermined thickness.

The collimator 117 is a lead plate or the like for narrowing the irradiation range of X-rays transmitted through the wedge 116, and forms a slit by combining a plurality of lead plates or the like. The collimator 117 may also be referred to as an x-ray diaphragm. FIG. 1 illustrates a case in which the wedge 116 is placed between the X-ray tube 111 and the collimator 117; however, the collimator 117 may also be placed between the X-ray tube 111 and the wedge 116. In this case, the wedge 116 attenuates X-rays emitted from the X-ray tube 111 and having an irradiation range limited by the collimator 117 by allowing the X-rays to pass therethrough.

The X-ray high voltage device 114 has electrical circuitry such as a transformer and a rectifier, a high voltage generator that generates a high voltage to be applied to the X-ray tube 111, and an X-ray controller that controls an output voltage corresponding to X-rays generated by the X-ray tube 111. The high voltage generator may be of a transformer type or an inverter type. The X-ray high voltage device 114 may be installed in the rotating frame 113 or in a fixed frame (not illustrated).

The control device 115 includes processing circuitry having a central processing unit (CPU) or the like, and a drive mechanism such as a motor and an actuator. The control device 115 receives input signals from an input interface 143 and controls the operations of the gantry device 110 and the couch device 130. For example, the control device 115 controls the rotation of the rotating frame 113, the tilt of the gantry device 110, the operations of the couch device 130 and a couchtop 133, and the like. The control device 115 may be installed in the gantry device 110 or in the image information processing apparatus 140.

The X-ray detector 112 is, for example, a photon-counting or energy-integrating detector. When the X-ray detector 112 is a photon-detecting detector, the X-ray detector 112 outputs a signal upon receiving an X-ray photon being a photon originating from X-rays emitted from the X-ray tube 111 and transmitted through the subject P, the signal being able to measure an energy value of the X-ray photon. The X-ray detector 112 has a plurality of X-ray detector elements that output one pulse of electrical signal (analog signal) upon receiving the X-ray photon.

The X-ray detector element is, for example, a semiconductor element (semiconductor detector element), such as cadmium telluride (CdTe) or cadmium zinc telluride (CdZnTe), in which anode and cathode electrodes are arranged.

The X-ray detector 112 has a plurality of X-ray detector elements and a plurality of application specific integrated circuits (ASIC) each being a readout circuit connected to the X-ray detector element to count an X-ray photon detected by the X-ray detector element. The ASIC counts the number of X-ray photons incident on the detector element by discriminating individual charges output by the X-ray detector element. The ASIC also measures the energy of the counted X-ray photons by performing arithmetic processing based on the magnitude of the individual charges. Moreover, the ASIC outputs the results of counting the X-ray photons to the DAS 118 as digital data.

The DAS 118 generates detection data on the basis of the results of the counting process input from the X-ray detector 112. The detection data is, for example, a sinogram. The sinogram is data that lines up the results of the counting process incident on each x-ray detector element at each position of the X-ray tube 111. The sinogram is data in which the results of the counting process are arranged in a two-dimensional orthogonal coordinate system with axes in view and channel directions. The DAS 118 generates sinograms, for example, on a per-slice column basis in the slice direction in the X-ray detector 112. The DAS 118 forwards the generated detection data to the image information processing apparatus 140. The DAS 118 is implemented with, for example, a processor.

The data generated by the DAS 118 is transmitted by optical communication from a transmitter with a light emitting diode (LED) installed in the rotating frame 113 to a receiver with a photodiode (not illustrated in FIG. 1) installed in a non-rotating part (for example, a fixed frame or the like) of the gantry device 110, and the data is then forwarded to the image information processing apparatus 140. The non-rotating part is, for example, a fixed frame that rotatably supports the rotating frame 113. The method of transmitting data from the rotating frame 113 to the non-rotating part of the gantry device 110 is not limited to optical communication; however, any non-contact data transmission method may be used or a contact data transmission method may be used.

The couch device 130 is a device for placing and moving the subject P to be photographed, and has a base 131, a couch drive device 132, the couchtop 133, and a support frame 134. The base 131 is a housing that supports the support frame 134 in a vertically movable manner. The couch drive device 132 is a drive mechanism that moves the couchtop 133, on which the subject P is placed, in the direction of a long axis of the couchtop 133, and includes a motor, an actuator, and the like. The couchtop 133 on a top surface of the support frame 134 is a board on which the subject P is placed. In addition to the couchtop 133, the couch drive device 132 may move the support frame 134 in the direction of the long axis of the couchtop 133.

The image information processing apparatus 140 has a memory 141, a display 142, the input interface 143, and processing circuitry 144. The image information processing apparatus 140 is described as a separate entity from the gantry device 110; however, the gantry device 110 may include some of the components of the image information processing apparatus 140.

The memory 141 is implemented with a semiconductor memory element such as a random access memory (RAM) and a flash memory, a hard disk, an optical disk, or the like. The memory 141 stores, for example, projection data and CT image data. For example, the memory 141 stores computer programs for the circuitry included in the X-ray CT apparatus 101 to implement various functions thereof. The memory 141 may be implemented with a server group (cloud) connected to the X-ray CT apparatus 101 via a network.

The display 142 displays various information. For example, the display 142 displays various images generated by the processing circuitry 144 or displays a graphical user interface (GUI) for receiving various operations from an operator. For example, the display 142 is a liquid crystal display or a cathode ray tube (CRT) display. The display 142 may be of a desktop type, or may be configured as a tablet terminal or the like capable of wirelessly communicating with a body of the image information processing apparatus 140. The display 142 is an example of a display unit.

The input interface 143 receives various input operations from the operator, converts the received input operations into electrical signals, and outputs the electrical signals to the processing circuitry 144. For example, the input interface 143 receives, from the operator, input operations such as scan conditions, reconstruction conditions for reconstructing CT image data, and image processing conditions for generating post-processed images from the CT image data.

For example, the input interface 143 is implemented with a mouse, a keyboard, a trackball, a switch, a button, a joystick, a touchpad for performing input operations by touching an operation surface, a touchscreen that integrates a display screen and a touchpad, non-contact input circuitry using an optical sensor, voice input circuitry, and the like. The input interface 143 may be provided on the gantry device 110. The input interface 143 may be configured as a tablet terminal or the like capable of wirelessly communicating with the body of the image information processing apparatus 140. The input interface 143 is not limited only to those with physical operating components such as a mouse and a keyboard. For example, an example of the input interface 143 also includes electrical signal processing circuitry that receives electrical signals corresponding to input operations from an external input device provided separately from the image information processing apparatus 140 and outputs the electrical signals to the processing circuitry 144.

The processing circuitry 144 controls the operation of the entire X-ray CT apparatus 101. For example, the processing circuitry 144 performs a control function 144a, a preprocessing function 144b, an acquisition function 144c, a setting function 144d, a calculation function 144e, and a correction function 144f. For example, each processing function performed by the control function 144a, the preprocessing function 144b, the acquisition function 144c, the setting function 144d, the calculation function 144e, and the correction function 144f, which are components of the processing circuitry 144 illustrated in FIG. 1, is recorded in the memory 141 in the form of a computer program executable by a computer. The processing circuitry 144 is, for example, a processor, and reads the computer programs from the memory 141 and executes the read computer programs, thereby implementing functions corresponding to the executed computer programs. In other words, the processing circuitry 144 in the state of reading the computer programs has each of the functions illustrated in the processing circuitry 144 in FIG. 1.

The control function 144a, the preprocessing function 144b, the acquisition function 144c, the setting function 144d, the calculation function 144e, and the correction function 144f are examples of a control unit, a preprocessing unit, an acquisition unit, a setting unit, a calculation unit, and a correction unit, respectively. The control unit is also an example of a display control unit. The memory 141 is an example of a storage unit.

FIG. 1 illustrates a case in which each processing function of the control function 144a, the preprocessing function 144b, the acquisition function 144c, the setting function 144d, the calculation function 144e, and the correction function 144f is implemented with single processing circuitry 144; however, the embodiment is not limited thereto. For example, the processing circuitry 144 may be configured by combining a plurality of independent processors, and respective processors may implement respective processing functions by executing respective computer programs. The processing functions of the processing circuitry 144 may be implemented by being appropriately distributed or integrated into single processing circuitry or a plurality of pieces of processing circuitry.

The control function 144a controls various processes on the basis of input operations received from the operator via the input interface 143. Specifically, the control function 144a controls CT scans performed on the gantry device 110. For example, the control function 144a controls a collection process of counting results on the gantry device 110 by controlling the operations of the X-ray high voltage device 114, the X-ray detector 112, the control device 115, the DAS 118, and the couch drive device 132. In one example, the control function 144a controls a collection process of projection data in a positioning scan for collecting positioning images (scout images) and in the imaging (main scan) for collecting images used for diagnosis.

In addition, the control function 144a, as a display control unit, causes the display 142 to display images or the like based on various image data stored in the memory 141.

The preprocessing function 144b generates projection data by performing preprocessing, such as logarithmic transformation processing, offset correction processing, inter-channel sensitivity correction processing, beam hardening correction, scattered ray correction, and dark count correction, on the detection data output from the DAS 118.

The processing circuitry 144 acquires various data from the X-ray detector 112 by using the acquisition function 144c. Details of the setting function 144d, the calculation function 144e, and the correction function 144f are described below.

On the basis of this background, the image information processing apparatus according to the embodiment includes an acquisition unit, a setting unit, a calculation unit, and a correction unit. The acquisition unit acquires a structure from a medical image. The setting unit sets one or more lines or planes that divide the structure into a plurality of regions. The calculation unit calculates feature quantities related to the form of the structure for each of the regions. The correction unit corrects the structure so that the difference in the feature quantities is reduced.

The image information processing method according to the embodiment acquires a structure from a medical image, sets lines or planes that divide the structure into a plurality of regions, calculates feature quantities related to the form of the structure for each of the regions, and corrects the structure so that the difference in the feature quantities is reduced.

A computer program according to the embodiment also causes a computer to perform a process of acquiring a structure from a medical image, setting one or more lines or planes that divide the structure into a plurality of regions, calculating feature quantities related to the form of the structure for each of the of regions, and correcting the structure so that the difference in the feature quantities is reduced.

That is, the image information processing apparatus according to the embodiment performs a correction process so that the difference in feature quantities at each of positions corresponding to a reference plane or the like, which divides the structure acquired from the medical image, is reduced. The corresponding position is, for example, a symmetrical position, and the feature quantity is, for example, the length of anatomical structure. This allows the correction process to reflect the left-right symmetry or the like of the anatomical structure while keeping anatomical feature quantities in a reasonable form.

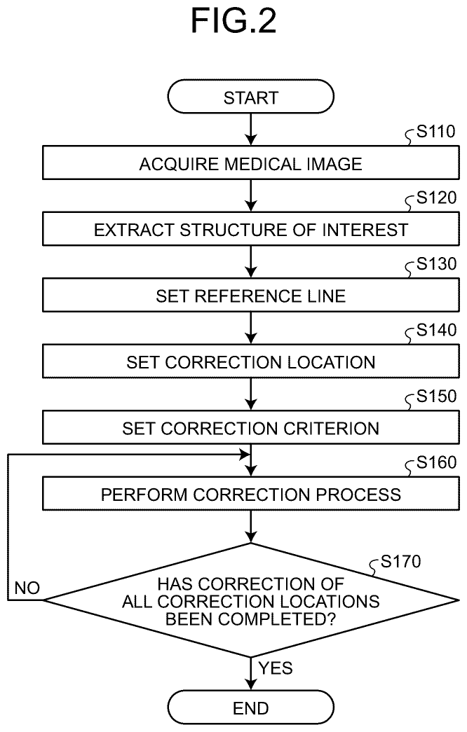

A process performed by the image information processing apparatus 140 according to the embodiment is described below with reference to FIG. 2 while referring to FIGS. 2 to 13 as appropriate.

First, at step S110, the processing circuitry 144 acquires, by using the acquisition function 144c, an X-ray CT image of a subject as a medical image from the X-ray CT apparatus 101 or an in-hospital image database connected to the image information processing apparatus 140. As an example of a condition for starting step S110, the processing circuitry 144 may acquire a CT image of the subject as the medical image by using the acquisition function 144c upon receiving an instruction from a user as a trigger.

As another example, the processing circuitry 144 or another processing circuitry may monitor a medical image storage device such as a PACS, and when the processing circuitry 144 or the other processing circuitry detects that a new image has been stored in that medical image storage device, the processing circuitry 144 may start the process of step S110.

As another example, the processing circuitry 144 may determine whether the new image satisfies predetermined conditions, and start the process of step S110 when the new image satisfies the predetermined conditions. Examples of such predetermined conditions include conditions related to an imaging protocol such as a condition that the new image was captured with an imaging protocol targeting the heart, and conditions related to a reconstruction method such as a condition that the new image is an enlarged and reconstructed image.

The medical image acquired by the processing circuitry 144 at step S110 is not limited to an X-ray CT image, but may be any other type of image in which structural information on the three-dimensional anatomical structure of a target biological tissue is stored. As an example, the medical image acquired by the processing circuitry 144 at step S110 may be an ultrasound image, an MRI image, an X-ray image, a PET image, or a SPECT image, or a four-dimensional image obtained by taking a plurality of these images in the time direction.

Subsequently, at step S120, the processing circuitry 144 extracts a structure of interest by using the acquisition function 144c. That is, the processing circuitry 144 acquires, by using the acquisition function 144c, a predetermined structure from the medical image acquired at step S110. For example, the processing circuitry 144 acquires the shape information of anatomical structure in the medical image as a predetermined structure by using the acquisition function 144c. That is, the processing circuitry 144 extracts, by using the acquisition function 144c, a region indicating the target anatomical structure as the predetermined structure from the CT image acquired at step S110.

For example, the processing circuitry 144 extracts, by using the acquisition function 144c, a region of a mitral valve and acquires the coordinate information of pixels in the region of the mitral valve. At step S120, the processing circuitry 144 may extract, by using the acquisition function 144c, the predetermined structure by receiving manual designation of the position of the structure of interest using the user interface, or may automatically extract the predetermined structure by using known region extraction techniques. Examples of such region extraction techniques include the Otsu binarization method based on CT values, the region expansion method, the snake method, the graph cut method, and the Mean Shift method.

The example of extracting the predetermined structure at step S120 is not limited to the method described above, and the processing circuitry 144 may acquire, by using the acquisition function 144c, the predetermined structure by extracting the predetermined structure from a shape model constructed by learning learning data prepared in advance using machine learning technology including deep learning.

As another example, the processing circuitry 144 may extract, by using the acquisition function 144c, a related region being a region larger than the region of the target anatomical structure but smaller than the region of the entire image acquired at step S110, and use the above-described method for the related region. This can reduce the computational cost required at step S120.

As an example, when the mitral valve is acquired as the predetermined structure, the processing circuitry 144 extracts, by using the acquisition function 144c, a heart region as a related region and acquires the predetermined structure from the related region by using known region extraction techniques or the like. As another example, the processing circuitry 144 may extract, by using the acquisition function 144c, the region of the sum set of the region of the left atrium and the region of the right atrium, for example, as a related region, and acquire the predetermined structure from the related region by using known region extraction techniques or the like. In setting the related region, the processing circuitry 144 may set, by using the acquisition function 144c, the related region by receiving input from a user through the user interface.

The region indicating the target anatomical structure may be identified separately for each region with different features and characteristics within that region. As an example, in the case of extracting the mitral valve, since the mitral valve is constituted by two valve leaflets of the anterior leaflet and the posterior leaflet, the processing circuitry 144 may acquire, by using the acquisition function 144c, the predetermined structure by using the anterior leaflet region and the posterior leaflet region as a plurality of regions and using known region extraction techniques or the like for each of the regions.

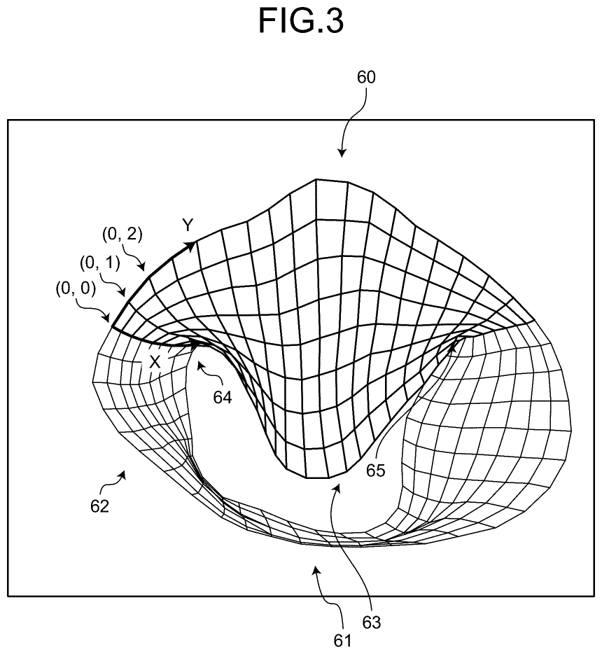

FIG. 3 illustrates an example of the predetermined structure of the mitral valve region extracted at step S120 by the processing circuitry 144 using the acquisition function 144c. In FIG. 3, an arrow 60 indicates the anterior leaflet and an arrow 61 indicates the posterior leaflet. An arrow 62 represents a valve annulus located at the most lateral site in the mitral valve region, and an arrow 63 represents a valve leaflet tip located at the most medial site in the mitral valve region. An arrow 64 represents an anterior commissure and an arrow 65 represents a posterior commissure.

FIG. 3 illustrates an example in which the processing circuitry 144 extracts the mitral valve region as a mesh represented by a group of grid points with 19 columns and 9 rows for the anterior leaflet region and 25 columns and 9 rows for the posterior leaflet region. As illustrated in FIG. 3, when the position of each grid point is expressed as an identifier (x, y) where x denotes the number of rows and y denotes the number of columns, (8, 0) indicates the anterior commissure and (8, 18) indicates the posterior commissure. The most lateral site in the anterior leaflet and the posterior leaflet, that is, the position of x=0 is called the valve annulus, and the most medial site, that is, the position of x=8 is called the valve leaflet tip.

FIG. 3 is merely one example of the predetermined structure extracted at step S120 by the processing circuitry 144 using the acquisition function 144c, and the number, arrangement, format of the array, and the like of lattice points may be different from the example illustrated in FIG. 3. Instead of extracting the mitral valve region as a mesh represented by a group of grid points described above, the processing circuitry 144 may extract the mitral valve region as a three-dimensional image represented by a set of corresponding pixels.

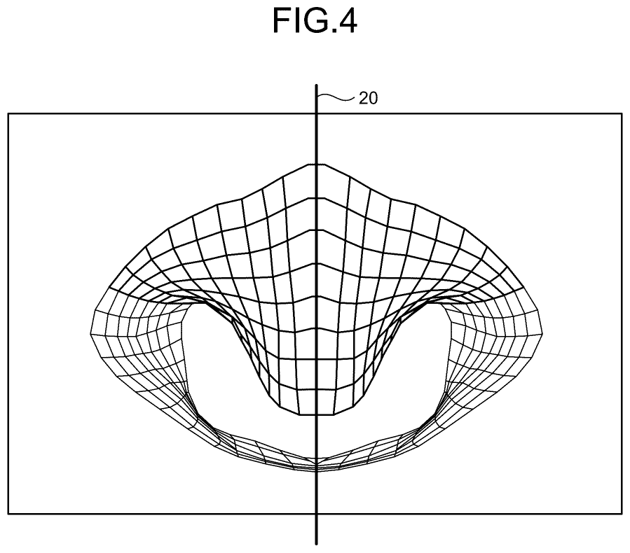

Subsequently, at step S130, the processing circuitry 144 sets, by using the setting function 144d, one or more lines or planes that divide the structure acquired from the medical image at step S120 into a plurality of regions. For example, the processing circuitry 144 sets, by using the setting function 144d, an axis serving as a reference for the left-right symmetry of the anatomical structure as the line or plane that divides the structure acquired from the medical image at step S120 into the regions. As an example, as illustrated in FIG. 4, the processing circuitry 144 sets, by using the setting function 144d, a reference line 20 for dividing the structure of the mitral valve region acquired from the X-ray CT image at step S120 into two regions. When the structure acquired at step S120 is not two-dimensional data but three-dimensional data, a reference plane, not a reference line, divides the structure acquired from the medical image at step S120.

As a method of setting the reference line 20, the processing circuitry 144 receives, by using the setting function 144d, input of the position of the reference line 20 through the input interface 143, and sets the reference line 20 on the basis of the received input. As an example, the processing circuitry 144 receives, by the setting function 144d, “y=10” as the position of the reference line 20 through the input interface 143. As a result, the processing circuitry 144 sets, by using the setting function 144d, a straight line connecting the coordinates (0, 10) and (8, 10) of the grid points as the reference line 20. As another example, the processing circuitry 144 may receive, by using the setting function 144d, a user's selection of a plurality of grid points from a group of grid points of a mesh through a user interface displayed on the display 142, and set the reference line 20 based on the selected grid points. In this case, as a possible user interface, the processing circuitry 144 may receive, by using the setting function 144d, input of grid points, for example, when a user clicks on a grid point displayed on the display 142 with a mouse or enters an identifier of the grid point with a keyboard.

As another example of the method for setting the reference line 20, the processing circuitry 144 may set a line segment or a polyline including a plurality of grid points at predetermined positions as the reference line 20 by using the setting function 144d. As an example, the processing circuitry 144 sets, by using the setting function 144d, a line connecting the grid points at y=10 in the anterior leaflet region, for example, as the reference line 20.

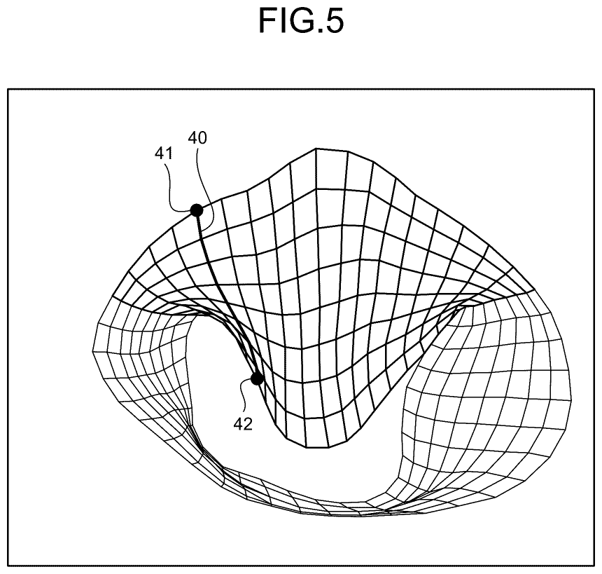

In the above example, a case has been described in which the processing circuitry 144 sets the axis of left-right symmetry in the entire anatomical structure as the reference line 20 by using the setting function 144d. However, the embodiment is not limited thereto, and the processing circuitry 144 may set a line other than the axis of left-right symmetry in the entire anatomical structure as the reference line 20 by using the setting function 144d. As an example, as illustrated in FIG. 5, the processing circuitry 144 may set, by using the setting function 144d, as a reference line, for example, the line connecting the position of a point 41, which indicates the position of the ¼ quantile of the valve annulus in the anterior leaflet region, and the position of a point 42, which indicates the position of the ¼ quantile of the valve leaflet tip, along a curved surface indicating the anterior leaflet region.

As another example, the processing circuitry 144 may set a plane passing through three predetermined points as the reference plane by using the setting function 144d. As an example, the processing circuitry 144 may set, by using the setting function 144d, as the reference plane, the plane passing through three points: the position of a midpoint of the valve annulus in the anterior leaflet region, the position of a midpoint of the valve leaflet tip in the anterior leaflet region, and the midpoint of a straight line connecting the anterior commissure and the posterior commissure.

In the above example, a case has been described in which the processing circuitry 144 sets, by using the setting function 144d, a reference line that divides the anterior leaflet region being a part of the region of the mitral valve into two regions. However, the embodiment is not limited thereto, and the processing circuitry 144 may also set, by using the setting function 144d, a reference line that divides the entire mitral valve region, the posterior leaflet region of the mitral valve region, or a partial region obtained by other division methods of the mitral valve region, into two regions.

In the above example, a case has been described in which the processing circuitry 144 sets, by using the setting function 144d, the reference line or the reference plane for dividing the structure acquired from the medical image at step S120 into two regions; however, the embodiment is not limited thereto. For example, the processing circuitry 144 may set, by using the setting function 144d, a reference line or a reference plane for dividing the structure acquired from the medical image at step S120 into three or more regions. As an example, the processing circuitry 144 may set, by using the setting function 144d, as a first reference line, a line connecting the position of a point, which indicates the position of the ⅓ quantile of the valve annulus in the anterior leaflet region of the mitral valve and the position of a point, which indicates the position of the ⅓ quantile of the valve leaflet tip, along a curved surface indicating the anterior leaflet region, and to set, as a second reference line, a line connecting the position of a point, which indicates the position of the ⅔ quantile of the valve annulus in the anterior leaflet region of the mitral valve and the position of a point, which indicates the position of the ⅔ quantile of the valve leaflet tip, along the curved surface indicating the anterior leaflet region.

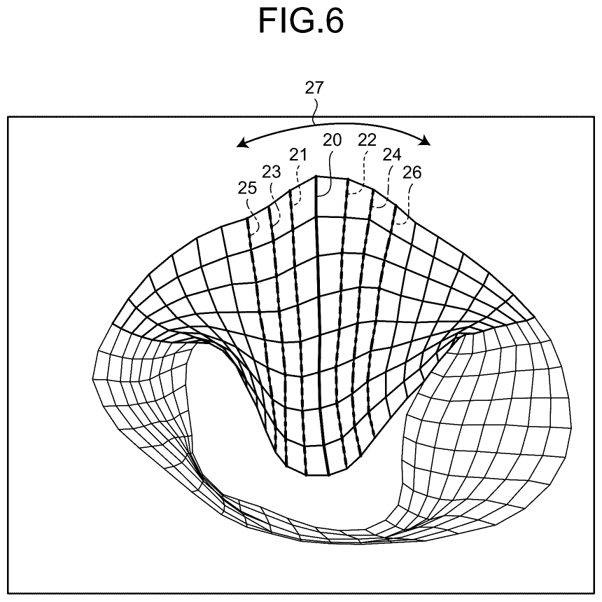

Subsequently, at step S140, the processing circuitry 144 sets, by using the setting function 144d, correction locations on the basis of the predetermined structure extracted at step S120. Such a situation is illustrated in FIG. 6. At step S140, on the basis of the reference line 20 set at step S130, the processing circuitry 144 sets a pair of lines or planes to be correction locations by using the setting function 144d. In the case of FIG. 6, on the basis of the reference line 20 set at step S130, the processing circuitry 144 sets a pair of broken lines to be the correction locations by using the setting function 144d. As another example, on the basis of the reference line 20 set at step S130, the processing circuitry 144 may set a pair of line segments to be the correction locations by using the setting function 144d.

The processing circuitry 144 calculates, by using the setting function 144d, feature quantities at each of corresponding locations with respect to the reference line 20, which serves as the axis of a reference for the left-right symmetry of the anatomical structure, set at step S130, for example. Specifically, the processing circuitry 144 sets, by using the setting function 144d, a pair of polylines at positions symmetrical with respect to the reference line 20 set at step S130 as a pair of lines to be the correction locations. As an example, the processing circuitry 144 sets, by using the setting function 144d, a polyline 21 and a polyline 22, which are approximately equal in distance from the reference line 20, as a pair of lines to be the correction locations. Similarly, the processing circuitry 144 sets, by using the setting function 144d, a polyline 23 and a polyline 24, which are approximately equal in distance from the reference line 20, as a pair of lines to be the correction locations. Similarly, the processing circuitry 144 sets, by using the setting function 144d, a polyline 25 and a polyline 26, which are approximately equal in distance from the reference line 20, as a pair of lines to be the correction locations.

In the above example, a case has been described in which the number of pairs of lines to be the correction locations is three, which is a plurality of pairs; however, the number of pairs of lines to be the correction locations is not limited thereto and for example, the number of pairs of lines to be the correction locations may be one.

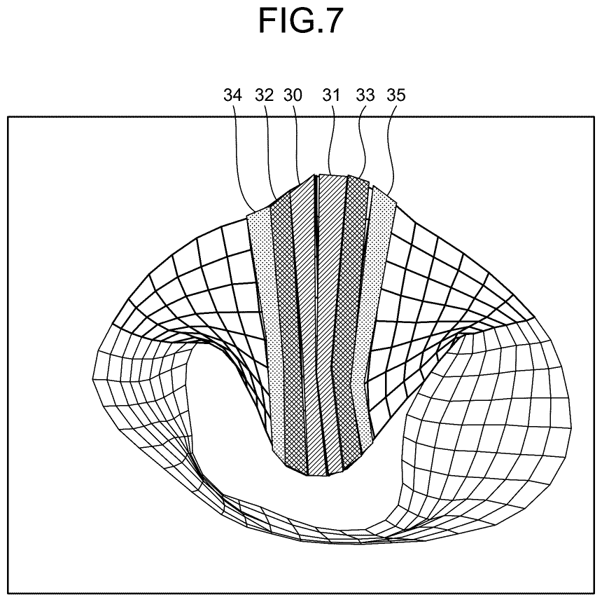

In the above example, a case has been described in which the shape of the correction location is a polyline. However, in the embodiment the shape of the correction location may be a one-dimensional line segment, a two-dimensional closed curve, a three-dimensional region, or a zero-dimensional point. FIG. 7 illustrates a case in which the shape of the correction location is a two-dimensional closed curve.

In this case, the processing circuitry 144 sets, by using the setting function 144d, a pair of closed curve 30 and closed curve 31, which are a pair of closed curves located symmetrically with respect to the reference line 20 set at step S130, as a pair of closed curves to be the correction locations. Similarly, the processing circuitry 144 sets, by using the setting function 144d, a pair of closed curve 32 and closed curve 33 and a pair of closed curve 34 and closed curve 35, which are pairs of closed curves located symmetrically with respect to the reference line 20 set at step S130, as pairs of closed curves to be the correction locations.

The correction locations may be automatically set at step S140 by the processing circuitry 144 using the setting function 144d based on predetermined criteria, or upon receiving input of correction locations from a user through the user interface, the processing circuitry 144 may set the correction locations by using the setting function 144d.

Instead of receiving input of correction locations from a user, the processing circuitry 144 may receive input of the range of correction locations from the user by using the setting function 144d. For example, in FIG. 6, when the processing circuitry 144 receives input of a range 27 of correction locations from the user through the user interface by using the setting function 144d, the processing circuitry 144 sets, by using the setting function 144d, the pair of polylines 21 and 22, the pair of polylines 23 and 24, and the pair of polylines 25 and 26, which are polylines included in the range 27 of correction locations, as pairs of lines to be the correction locations.

When the range 27 of correction locations received by the processing circuitry 144 from the user through the user interface by using the setting function 144d is not appropriate, the processing circuitry 144 may fail to set pairs of lines to be the correction locations within the range 27 of correction locations by using the setting function 144d. In such a case, the processing circuitry 144 may notify the user of the above situation and request the user to re-input the range 27 of correction locations, or the processing circuitry 144 may set a pair of lines that are to be the correction locations and are closest to given condition, as a pair of lines to be the correction locations by using the setting function 144d. In this way, on the basis of the line or plane, the processing circuitry 144 sets the correction locations from the structure by using the setting function 144d.

Subsequently, at step S150, the processing circuitry 144 sets, by using the setting function 144d, an evaluation value to be used as a reference when correcting the correction locations set at step S140. As an example, the processing circuitry 144 determines, by using the setting function 144d, what feature quantities are to be used as the basis for correction in correcting the correction locations set at step S140. As an example, when the type of correction location set at step S140 is a line, the feature quantity to be used as the basis for correction is the length of the line. As an example, when correcting the correction location set at step S140 by the setting function 144d, the processing circuitry 144 uses the length of the anatomical structure measured along the direction of the axis, which is the reference line set at step S130, as a feature quantity, to perform correction based on the feature quantity by using the correction function 144f.

As another example, the feature quantity on which the correction is based may be an angle. As an example, when correcting the correction location set at step S140 by the setting function 144d, the processing circuitry 144 uses, for example, an angle formed with a base plane or baseline obtained from a valve leaflet structure, as a feature quantity, to perform correction.

When the type of correction location set at step S140 is a closed curve, original feature quantities for correction are, for example, circumference, area, circularity, and the like. For example, when correcting the correction location set at step S140 by the setting function 144d, the processing circuitry 144 uses, for example, the area, circumference, and the like of a closed curve as feature quantities, to perform correction.

When the type of correction location set at step S140 is a three-dimensional region, the feature quantities are volume, surface area, sphericity, and the like. In this case, when correcting the correction location set at step S140 by the setting function 144d, the processing circuitry 144 uses, for example, volume, surface area, sphericity, and the like as feature quantities, to perform correction.

The setting of the feature quantities set at step S140 and serving as correction criteria may be done by the processing circuitry 144 through the user interface, manually receiving input from the user by the setting function 144d. As another example, feature quantities serving as correction criteria may be set automatically by predefined conditions. The feature quantities serving as correction criteria may be automatically determined according to the type of correction location set at step S140.

In the embodiment, a case in which step S150 is processed after step S140 is processed has been described; however, the embodiment is not limited thereto and step S140 may be processed after step S150 is processed. In this case, options incompatible with the correction criteria selected by the user at step S150 may be excluded in the process of step S140.

Subsequently, at step S160, on the basis of the correction criteria set at step S150, the processing circuitry 144 corrects the correction locations set at step S140 by using the correction function 144f.

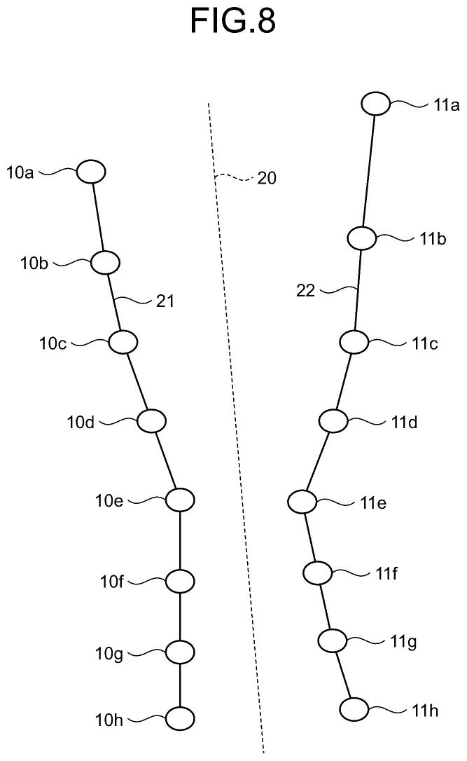

The process of step S160 is described with reference to FIGS. 8 to 11 for a case in which the type of correction location set at step S140 is a polyline and the feature quantity serving as the correction criterion set at step S150 is the length of the anatomical structure measured along the reference line 20. FIGS. 8 to 11 describe the process when the processing circuitry 144 performs correction using the correction function 144f, with the polyline 21 and the polyline 22 at the corresponding positions with respect to the reference line 20 in FIG. 6 as correction targets.

FIG. 8 illustrates the polyline 21 and the polyline 22 before being corrected, and grid points 10a, 10b, 10c, 10d, 10e, 10f, 10g, and 10h indicate the grid points of the polyline 21 and grid points 11a, 11b, 11c, 11d, 11e, 11f, 11g, and 11h indicate the grid points of the polyline 22. Each of the grid points 10a to 10h and 11a to 11h corresponds to the grid point in the mesh of FIG. 6. That is, in FIG. 8, the anatomical structure included in the medical image acquired at step S110 is a heart valve, and the processing circuitry 144 represents, by using the setting function 144d, the structure of interest acquired from that medical image at steps S120, S130, and S140 by using the polylines 21 to 26 along a direction from a valve leaflet tip to a valve annulus. Each of the polylines 21 to 26 is obtained by connecting line segments formed by connecting a plurality of grid points such as the grid points 10a to 10h and 11a to 11h.

First, the processing circuitry 144 calculates, by using the calculation function 144e, the feature quantities related to the form of the structure acquired from the medical image at step S110 for each of the regions. In the case of FIG. 8, the processing circuitry 144 uses the calculation function 144e to calculate, for example, the length of the polyline 21, which is the length of the anatomical structure measured along the reference line 20, and the length of the polyline 22, which is the length of the anatomical structure measured along the reference line 20, with respect to the polyline 21 located in the region to the left of the reference line 20 and the polyline 22 located in the region to the right of the reference line 20, respectively.

The feature quantity of the embodiment is not limited to the length of the line segment measured along the reference line 20, for example, the processing circuitry 144 may calculate the length of the polyline 21 and the length of the polyline 22 as the feature quantities by using the calculation function 144e.

As another example, the processing circuitry 144 may calculate, by using the calculation function 144e, the lengths of broken lines constituting the polyline 21 and the polyline 22, and calculate the mean, median, minimum, maximum values, and the like of the lengths of the broken lines as the feature quantities. In this way, the processing circuitry 144 calculates, by using the calculation function 144e, the feature quantities for the correction locations set by the setting function 144d.

Subsequently, the processing circuitry 144 corrects, by using the correction function 144f, the structure acquired from the medical image at step S110 so that the difference in the calculated feature quantities is reduced. As an example, the processing circuitry 144 corrects, by using the correction function 144f, the structure acquired from the medical image at step S110 so that the difference in the feature quantities calculated for each corresponding location is reduced.

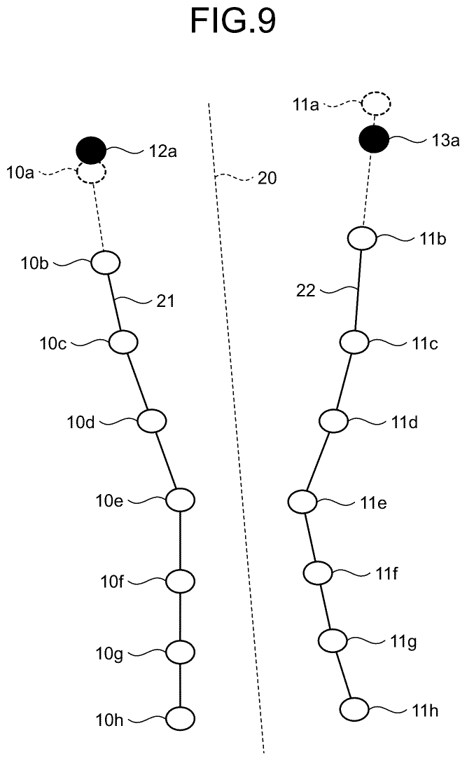

FIG. 9 illustrates an example of such a process. FIG. 9 is a diagram illustrating an example of the correction process performed by the processing circuitry 144 using the correction function 144f. The grid point 10a and the grid point 11a indicate grid points before the correction process, and the grid point 12a and the grid point 12b indicate grid points after the correction process. The processing circuitry 144 corrects, by using the correction function 144f, the structure acquired from the medical image by modifying the positions of the grid points on the valve annulus side among the grid points with respect to each of the polylines 21 to 26. For example, the processing circuitry 14 corrects, by using the correction function 144f, the structure acquired from the medical image by modifying the positions of the grid points 10a and 11a on the valve annulus side among the grid points 10a to 10h and 11a to 11h to the positions of the grid points 12a and 13a, respectively, with respect to the polyline 21 and the polyline 22. As an example, the processing circuitry 144 corrects, by using the correction function 144f, the positions of the grid points 10a and 11a on the valve annulus side to the positions of the grid points 12a and 13a, respectively, so that the lengths of the corrected polylines 21 and 22 are the average of the lengths of the polylines 21 and 22 before being corrected.

By moving only the endpoints on the valve annulus side in this way, the processing circuitry 144 according to the embodiment can correct the valve length to be bilaterally symmetrical without changing the valve orifice shape.

In cases in which the endpoints on the valve annulus side are not desired to be changed, the processing circuitry 144 may correct only grid points on the valve leaflet tip side instead of the grid points on the valve annulus side by using the correction function 144f. The processing circuitry 144 may also correct both the grid points on the valve annulus side and the grid points on the valve leaflet tip side by using the correction function 144f.

The method for the correction process performed by the processing circuitry 144 using the correction function 144f is not limited to the above example, and various methods are conceivable. As an example, for example, the processing circuitry 144, by using the correction function 144f, may identify the grid points 12a and 13a at which the length of the polyline 21 after being corrected is the length of the polyline 22 before being corrected and the length of the polyline 22 after being corrected is the length of the polyline 21 before being corrected, and may correct the positions of the grid points 10a and 11a to be a midpoint between 10a and 12a and a midpoint between 11a and 13a. The processing circuitry 144 may also calculate the lengths of the broken lines constituting the polylines 21 and 22, and calculate the mean, median, minimum, maximum values, and the like of the lengths of the broken lines as feature quantities, and perform the correction process so that, for example, the mean value and the like of the lengths of the broken lines match the length between the corrected grid point 10b and grid point 12a and the length between the corrected grid point 11b, respectively. In this way, the processing circuitry 144 corrects, by using the correction function 144f, the structure by using length, angle, circumference, area, and the like as correction criteria.

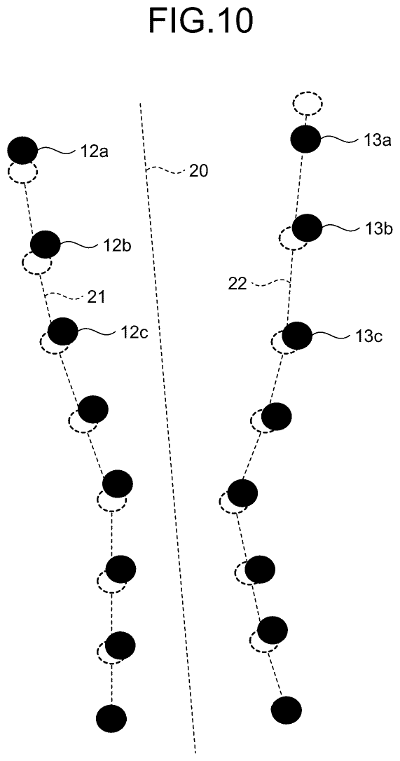

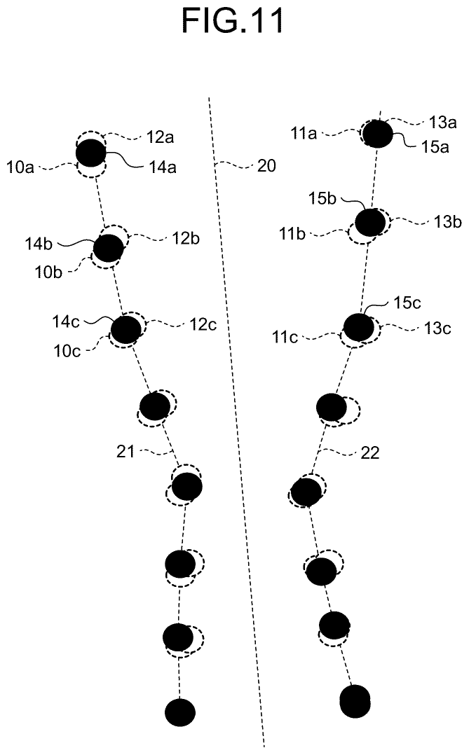

As an optional component, the processing circuitry 144 according to the embodiment may also correct the polyline 21 and the polyline 22 by further performing an additional process illustrated in FIG. 10 or FIG. 11. For example, on the basis of the modified grid points 12a and 13a illustrated in FIG. 9 and the grid points 10b to 10h and 11b to 11h before being modified illustrated in FIG. 9, the processing circuitry 144 updates the positions of a plurality of grid points by rearranging the grid points as illustrated in FIG. 10 by using the correction function 144f. For example, on the basis of the modified grid points 12a and the like and the grid points 10b to 10h before being modified, the processing circuitry 144 updates, by using the correction function 144f, the positions of a plurality of grid points by rearranging the grid points so that the distances between these grid points are equally spaced, and generates rearranged grid points 12a, 12b, 12c, and the like. On the basis of the modified grid point 13a and the grid points 11b to 10h before being modified, the processing circuitry 144 updates, by using the correction function 144f, the positions of a plurality of grid points by rearranging the grid points so that the distances between these grid points are equally spaced, and generates rearranged grid points 13a, 13b, 13c, and the like.

This rearrangement of the grid points so that the distances between the grid points are equally spaced may facilitate post-processing such as the calculation of measurement values, for example.

As an optional component, for example, as illustrated in FIG. 11, the processing circuitry 144 further updates, by using the correction function 144f, the positions of the grid points by performing a weighted addition between the positions of the updated grid points 12a to 12c and the like and the positions of the grid points 10a to 10c before being updated, generates a plurality of grid points 14a to 14c, and corrects the structure of interest extracted from the medical image at step S120. As an example, the processing circuitry 144 takes, by using the correction function 144f, midpoints between the positions of the updated grid points 12a to 12c and the like and the positions of the of grid points 10a to 10c and the like before being updated, respectively, further updates the positions of the grid points, and generates a plurality of grid points 14a to 14c. This corrects the structure of interest extracted from the medical image at step S120. Similarly, the processing circuitry 144 performs, by using the correction function 144f, a weighted addition between the positions of the updated grid points 13a to 13c and the like and the positions of the grid points 11a to 11c and the like before being updated. This further updates the positions of the grid points and generates a plurality of grid points 15a to 15c, and corrects the structure of interest extracted from the medical image at step S120.

As a further optional component, the processing circuitry 144 may rearrange, by using the correction function 144f, the grid points illustrated in FIG. 10 for the grid points obtained in the procedure illustrated in FIG. 11, so that the grid points are equally spaced.

As a further optional component, the processing circuitry 144 may correct the structure extracted from the medical image by repeating, a plurality of times, a series of steps illustrated in FIGS. 8 to 11 or a series of steps illustrated in FIGS. 8 to 11 followed by a further step of rearranging the grid points illustrated in FIG. 10.

In the process illustrated in FIG. 9, the case of correcting the grid points 10a and 11a on the valve annulus side based on the average value of the polyline 21 and the polyline 22 is described as a method of correcting the grid points 10a and 11a on the valve annulus side; however, as described above, the embodiment can be done in various ways such as modifying the grid point 10a on the valve annulus side of the polyline 21 based on the length of the polyline 22 before being corrected and modifying the grid point 11a on the valve annulus side of the polyline 22 based on the length of the polyline 21 before being corrected. The processing circuitry 144 according to the embodiment can also execute a series of steps in FIGS. 8 to 11 by replacing the steps in FIG. 9 with the various methods described above.

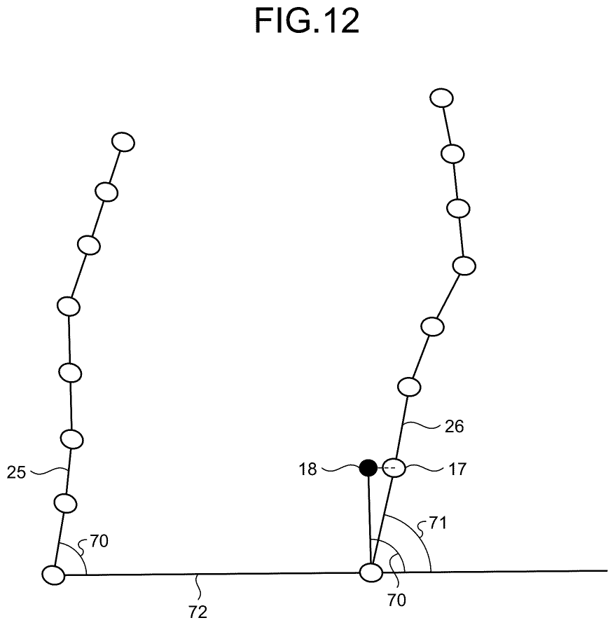

The correction process of step S160 when the feature quantity serving as the correction criterion set at step S150 is an angle is described below with reference to FIG. 12. FIG. 12 is a diagram explaining the correction process of step S160 when the feature quantity serving as the correction criterion set at step S150 is an angle. The processing circuitry 144 corrects, by using the correction function 144f, the structure extracted from the medical image, based on the angle between the base plane or baseline obtained from the valve leaflet tip structure and each of the line segments. In FIG. 12, the processing circuitry 144 corrects the polylines 25 and 26 illustrated in FIG. 6 by using the correction function 144f. That is, FIG. 12 corresponds to a lateral view of a screen for the three-dimensional structure illustrated in FIG. 6. A straight line 72 indicates the base plane or baseline obtained from the structure of the valve leaflet tip structure, specifically, a least-squares plane of the closed curve formed by the valve leaflet tip.

First, the processing circuitry 144 calculates, by using the correction function 144f, an angle 70 formed by the polyline 25 and the straight line 72 being the base plane or baseline obtained from the valve leaflet tip structure.

The method of calculating the angle formed by the polyline and the base plane or baseline is described below. For example, when the polyline 25 and the straight line 72 intersect, the processing circuitry 144 calculates, by using the correction function 144f, the angle formed by the polyline 25 and the straight line 72 at the intersection of the polyline 25 and the straight line 72, as the angle 70 formed by the polyline 25 and the straight line 72. On the other hand, for example, when the polyline 25 and the straight line 72 have no intersection, the processing circuitry 144 calculates, by using the correction function 14f, an angle formed by a straight line obtained by extrapolating the polyline 25 and the straight line 72 at the intersection of the straight line obtained by extrapolating the polyline 25 and the straight line 72, as the angle 70 formed by the polyline 25 and the straight line 72.

As another example of the method for calculating the angle formed by the polyline and the base plane or baseline, the processing circuitry 144 may calculate, by using the correction function 144f, an approximate straight line of the polyline 25, for example, by using the least-squares method, and calculate an angle formed between the approximate straight line and the straight line 72 as the angle formed by the polyline and the base plane or baseline.

Similarly, the processing circuitry 144 calculates an angle 71 formed by the polyline 26 and the straight line 72 by using the correction function 144f.

Subsequently, the processing circuitry 144 corrects, by using the correction function 144f, the positions of the grid points so that the angle 70 formed by the polyline 25 and the straight line 72 matches the angle 71 formed by the polyline 26 and the straight line 72. As an example, the processing circuitry 144 corrects, by using the correction function 144f, the position of a grid point 17 at the valve leaflet tip of the polyline 26 to the position of a grid point 18 so that an angle formed by the polyline 26 and the straight line 72 after being corrected matches the angle 70 formed by the polyline 25 and the straight line 72. At this time, the processing circuitry 144 corrects, by using the correction function 144f, the position of the grid point 17 to the position of the grid point 18 by translating the position of the grid point 17 in a direction parallel to the straight line 72.

The processing circuitry 144 may match, by using the correction function 144f, the smaller angle out of the angle 70 and the angle 71 to the larger one out of the angle 70 and the angle 71, or match the larger one to the smaller one. As another example, the processing circuitry 144 may correct, by using the correction function 144f, the polyline 25 and the polyline 26 so that the angle formed with the straight line 72 after being corrected is the average of the angle 70 and the angle 71.

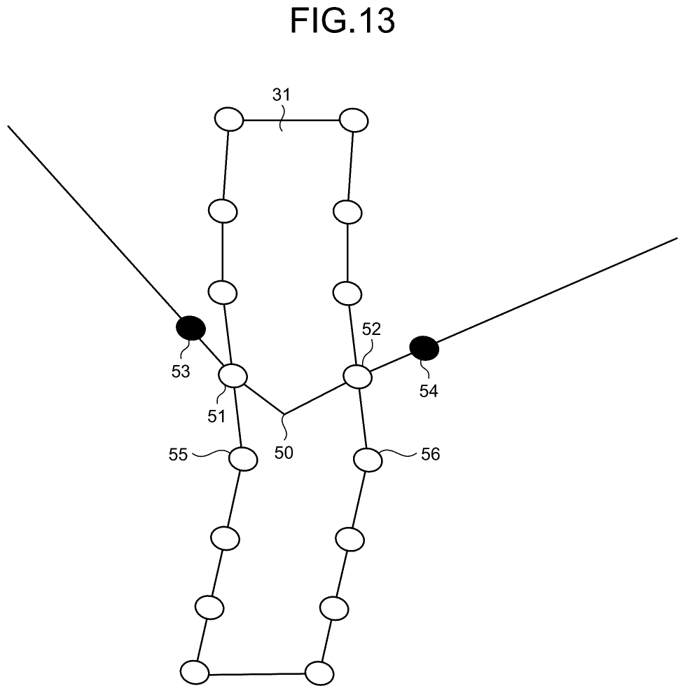

Next, the correction process of step S160 when the correction location set at step S140 is a closed curve and the feature quantity serving as the correction criterion set at step S150 is circumference or area is described with reference to FIG. 13.

FIG. 13 is a diagram explaining the correction process of step S160 when the feature quantity serving as the correction criterion set at step S150 is circumference or area. Specifically, FIG. 13 illustrates a case in which the processing circuitry 144 performs the correction process on a closed curve 31 in FIG. 7 by using the correction function 144f. Grid points 51, 52, 55, 56, and the like in FIG. 13 are grid points in the closed curve 31.

The processing circuitry 144 calculates the center 50 of gravity of the closed curve 31 by using the correction function 144f. Subsequently, the processing circuitry 144 performs, by using the correction function 144f, a correction process on the closed curve 31 by, for example, adjusting the distance of the grid point 51 and the grid point 52 from the center 50 of gravity, and, for example, adjusting the grid point 51 to the grid point 53 and adjusting the grid point 52 to the grid point 54. As an example, the processing circuitry 144 modifies, by using the correction function 144f, the positions of the grid point 51 and the grid point 52 included in the closed curve 31 to a grid point 53 and a grid point 54, respectively, so that the circumference or area of the corrected closed curve 31 is equal to the circumference or area of the closed curve 30.

Subsequently, at step S170, the processing circuitry 144 determines, by using a determination function (not illustrated), whether the correction of all correction locations set by the setting function 144d at step S140 has been completed. When all the correction locations set at step S140 have been corrected (Yes at step S170), the correction process ends. On the other hand, when there are locations where the correction process has not been performed (No at step S170), the procedure returns to step S160, and the processing circuitry 144 performs, by using the correction function 144f, the correction process of step S160 for a pair of the correction locations where the correction process has not been completed.

The processing circuitry 144 normally performs, by using the correction function 144f, the same type of correction process for all the correction locations set at step S140; however, the embodiment is not limited thereto. The processing circuitry 144 may change, by using the correction function 144f, the process of the correction method according to the correction locations set at step S140. As an example, the processing circuitry 144 may change, by using the correction function 144f, the method for the correction process performed at step S160 according to the distance from the reference line 20 set at step S130.

The embodiment is not limited to a case in which the correction process is performed for all the correction target locations, but the correction process may be performed only for some of the correction locations set at step S140. As an example, the processing circuitry 144 may further perform a process of determining whether to perform the correction process for each pair of correction locations at step S170. As an example, when the processing circuitry 144 first calculates, by using the calculation function 144e, the correction criteria at step S160 with respect to a pair of correction locations set at step S140 and the difference in the correction criteria for the pair of correction locations is equal to or less than a threshold value, the processing circuitry 144 may perform no correction process for the correction locations at step S160. The threshold value may be set in advance, or may be set by receiving user input from the user interface. As another example, at step S140 or step S150, the processing circuitry 144 may calculate the difference in the correction criteria by using the correction function 144f, and it is possible not to set pairs whose difference of the correction criteria is below the threshold value as correction locations at step S160.

As described above, in the first embodiment, the processing circuitry 440 sets a line or plane that divides a structure acquired from a medical image by using the setting function 144d, calculates feature quantities related to the form of the structure for each of a plurality of regions by using the calculation function 144e, and corrects the structure so that the difference in the feature quantities is reduced. As an example, the processing circuitry 440 performs a correction process so that corresponding feature quantities, for example, anatomical structure lengths, are matched at corresponding positions, for example, symmetrical positions, relative to a reference plane or the like that divides the structure acquired from the medical image. This allows the correction process to reflect the left-right symmetry or the like of the anatomical structure while keeping anatomical feature quantities in a reasonable form.

### First Variation of First Embodiment

The first embodiment has described a case in which the processing circuitry 144 sets lines or planes that divide a structure acquired from a medical image into a plurality of regions by using the setting function 144d, calculates feature quantities related to the form of the structure for each of the regions by using the calculation function 144e, and corrects the structure by using the correction function 144f so that the difference in the feature quantities is reduced. However, the embodiment is not limited thereto, and the processing circuitry 144 may calculate an evaluation value on the basis of the form and shape of the structure by using the calculation function 144e, and select a method of correcting the structure on the basis of the calculated evaluation value, by using the correction function 144f.

The form and shape here is, for example, a curvature. That is, the processing circuitry 144 may calculate, by using the correction function 144f, the curvature as an evaluation value for each of the divided regions, and select a method of correcting the structure on the basis of the calculated evaluation value. As an example, when the curvature is large, the reliability of the process by which the processing circuitry 144 acquires the structure by using the acquisition function 144c at step S120 may be low. In this case, at step S160, for example, the processing circuitry 144 corrects, by using the correction function 144f, a structure with a higher curvature to match a structure with a lower curvature among the pairs set for the correction locations at step S140. That is, the processing circuitry 144 selects, by using the correction function 144f, a method of correcting a first correction location in accordance with a second correction location when the curvature of the first correction location is greater than the curvature of the second correction location among the pairs set for the correction locations at step S140, and selects a method of correcting the second correction location in accordance with the first correction location when the curvature of the first correction location is smaller than the curvature of the second correction location. In other words, the processing circuitry 144 selects, by using the correction function 144f, a method of correcting the structure according to the reliability of the process of acquiring the structure.

As another example, when the difference in shape between correction locations in the same pair is large compared to another pair set for correction locations at step S140, since the reliability of the process of acquiring the structure at step S120 in that pair may be low, the processing circuitry 144 may correct, by using the correction function 144f, correction locations of a pair with a large difference in shape between the correction locations in accordance with correction locations of a pair with a small difference in shape between the correction locations.

As another example, when performing the process of step S120 for each of the divided regions, the processing circuitry 144 may calculate, by using the calculation function 144e, the likelihood of the structure acquired from the medical image for each pixel, that is, the probability of the pixel being the structure, as an evaluation value for each pixel, and select, by using the correction function 144f, a method of correcting the structure on the basis of the calculated evaluation value. Here, the processing circuitry 144 calculates the likelihood using, for example, U-Net, by using the calculation function 144e. A correction location including more pixels with high likelihood among the pairs set for the correction locations is considered to be more reliable than another correction location including more pixels with low likelihood. Accordingly, the processing circuitry 144 corrects, by using the correction function 144f, the other correction location in accordance with the correction location including more pixels with high likelihood.

As described above, in the first variation of the first embodiment, the processing circuitry 144 calculates an evaluation value and the like, and further changes a method for the correction process based on the calculated evaluation value and the like. This further improves the accuracy of the correction process.

### Second Variation of First Embodiment

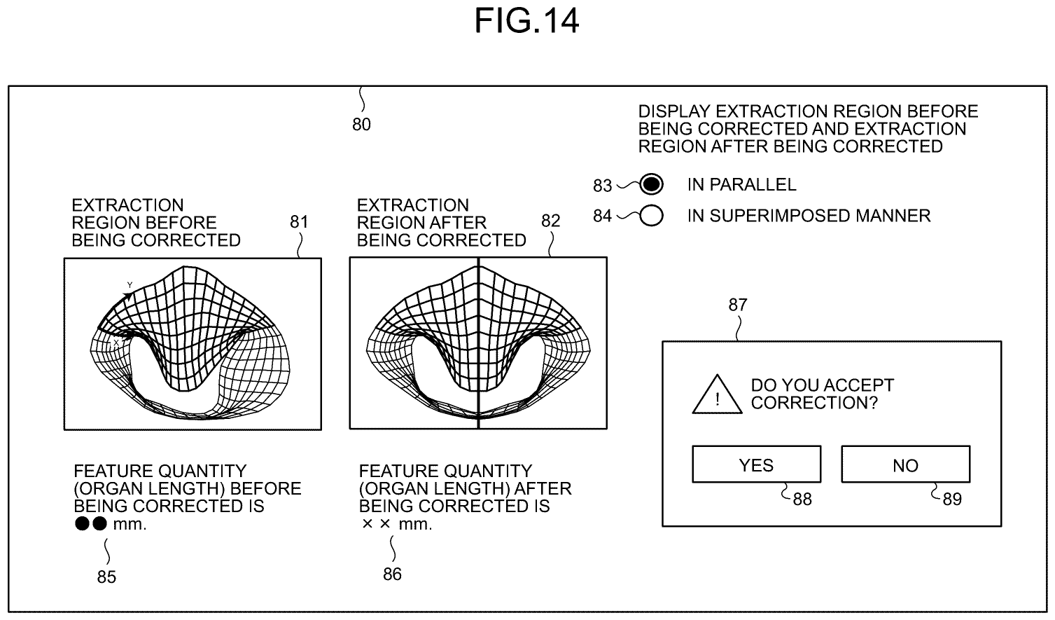

The second variation of the first form describes a user interface that displays a corrected image to a user. FIG. 14 illustrates an example of such a user interface. When correction of all correction locations is completed at step S170, the processing circuitry 144 causes a display screen 80 of the display 142 to display an image 82 of a structure including corrected correction locations by using the control function 144a. Upon receiving an instruction from a user through a button 83 to display a structure before being corrected and a structure after being corrected in parallel by using the control function 144a, the processing circuitry 144 causes the display 142 to display the image 82 after being corrected together with an image 81 before being corrected by using the control function 144a. Upon receiving an instruction from the user through a button 84 to display an image before being corrected and an image after being corrected in a superimposed manner by using the control function 144a, the processing circuitry 144 causes the display 142 to display the image before being corrected and the image after being corrected in a superimposed manner by using the control function 144a. That is, the processing circuitry 144 causes the display unit to display an image in which the structure before being corrected and a an image in which the structure after being corrected in a superimposed manner by using the control function 144a.

The processing circuitry 144 causes the display 142 to display a window 87 to ask the user, who has referred to the image 82 after being corrected, whether to accept the correction by using the control function 144a. When the processing circuitry 144 receives, by using the control function 144a, a user's selection to accept the correction through a button 88, the processing circuitry 144 receives the image 82 after being corrected as a correctly corrected medical image and stores the image 82 after being corrected in the memory 141. On the other hand, when the processing circuitry 144 receives, by using the control function 144a, a user's selection not to accept the correction through a button 89, the processing circuitry 144 discards the image 82 after being corrected and either terminates the process or performs the correction process by changing the conditions. In this case, the processing circuitry 144 may receive input of the changed conditions from the user by using the control function 144a.

As described above, in the second variation of the first embodiment, the processing circuitry 144 includes a user interface for performing a process such as displaying a corrected image to a user or receiving input from a user. This improves usability.

### Third Variation of First Embodiment

The embodiment is not limited to the above examples. As an example, at step S160, the processing circuitry 144 may calculate, by using the calculation function 144e, feature quantities or measurement values with respect to corrected correction locations, and display measurement values before being corrected and measurement values after being corrected to a user. As an example, as illustrated in FIG. 14, the processing circuitry 144 causes the display 142 to display the measurement values before being corrected as a message 85 directed to a user and to display the measurement values after being corrected on the display 142 as a message 86 directed to the user by using the control function 144a.

The processing circuitry 144 also causes the display 142 to display the window 87 to ask the user, who has referred to the message 86 directed to the user and related to the measurement values after being corrected, whether to accept the correction by using the control function 144a. When the processing circuitry 144 receives, by using the control function 144a, a user's selection to accept the correction through the button 88, the processing circuitry 144 receives the image 82 after being corrected as a correctly corrected medical image and stores the image 82 after being corrected in the memory 141. On the other hand, when the processing circuitry 144 receives, by using the control function 144a, a user's selection not to accept the correction through the button 89, the processing circuitry 144 discards the image 82 after being corrected and either terminates the process or performs the correction process by changing the conditions. In this case, the processing circuitry 144 may receive input of the changed conditions from the user by using the control function 144a.

As described above, in the third variation of the first embodiment, the processing circuitry 144 further displays measurement values for corrected correction locations to a user. This improves usability.

### Fourth Variation of First Embodiment

In the previous embodiments, a case in which a target anatomical structure is the mitral valve has been described; however, the embodiment is not limited thereto. In the embodiment, target organs may include organs other than the heart, such as the brain, vocal cords, and uterus. Since these organs each have an axis serving as a reference for the left-right symmetry of the organ, the processing circuitry 144 sets, by using the setting function 144d, a plane that divides the organ into a plurality of regions. The processing circuitry 144 corrects the structure by using the correction function 144f so that the difference in feature quantities is reduced for each of the regions. As in the case of the mitral valve, as an example, the processing circuitry 144 uses, by using the correction function 144f, the lengths of organs measured along the direction of a reference axis as feature quantities for each of corresponding locations with respect to the reference axis, and performs a correction process so that the difference in the lengths of the organs measured along the direction of the reference axis at each of the locations corresponding to the reference axis is reduced. This allows the processing circuitry 144 to perform the same correction process for organs other than the heart.

According to at least one of the embodiments described above, the extraction accuracy when extracting a region of a predetermined anatomical structure from a medical image and the calculation accuracy of various measurement values based on the region can be improved.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image information processing apparatus comprising:
processing circuitry configured
to acquire a structure from a medical image,
to set one or more lines or planes that divide the structure into a plurality of regions,
to calculate feature quantities related to a form of the structure for each of the regions, and
to correct the structure so that a difference in the feature quantities is reduced.

2. The image information processing apparatus according to claim 1, wherein the processing circuitry is configured to
acquire shape information of anatomical structure included in the medical image as the structure, and
set an axis serving as a reference of a left-right symmetry of the anatomical structure as one of the one or more lines or planes.

3. The image information processing apparatus according to claim 2, wherein the feature quantity is a length of the anatomical structure measured along a direction of the axis.

4. The image information processing apparatus according to claim 2, wherein the processing circuitry is configured to
calculate the feature quantities at each of corresponding locations with respect to the axis, and
correct the structure so that the difference in the feature quantities calculated for each of the corresponding locations is reduced.

5. The image information processing apparatus according to claim 2, wherein
the anatomical structure is a heart valve, and
the processing circuitry is configured to
represent the structure by using a plurality of polylines along a direction from a valve leaflet tip to a valve annulus, each of the polylines being obtained by connecting polylines formed by connecting a plurality of grid points, and
correct, for each of the polylines, the structure by modifying a position of the grid point on at least one of a valve annulus side and a valve leaflet tip side among the grid points.

6. The image information processing apparatus according to claim 5, wherein the processing circuitry is configured to
update positions of the grid points on a basis of the modified grid point, and
correct the structure by further updating the positions of the grid points by performing a weighted addition between the positions of the grid points after being updated and the positions of the grid points before being updated.

7. The image information processing apparatus according to claim 1, wherein the feature quantity is an angle formed with a base plane or baseline obtained from a structure of a valve leaflet tip.

8. The image information processing apparatus according to claim 1, wherein the feature quantity is an area or circumference of a closed curve.

9. The image information processing apparatus according to claim 1, wherein the processing circuitry is configured to
set correction locations from the structure on a basis of the lines or planes, and
calculate the feature quantities for the set correction locations.

10. The image information processing apparatus according to claim 1, wherein the processing circuitry is configured to correct the structure by using a length, an angle, a circumference, or an area as a correction criterion.

11. The image information processing apparatus according to claim 1, wherein the processing circuitry is configured to select a method of correcting the structure according to a reliability of a process of acquiring the structure.

12. The image information processing apparatus according to claim 1, wherein the processing circuitry causes a display unit to display an image in which the structure before correction and the structure after correction are superimposed on the image.

13. An image information processing method comprising:
acquiring a structure from a medical image;
setting one or more lines or planes that divide the structure into a plurality of regions;
calculating feature quantities related to a form of the structure for each of the regions; and
correcting the structure so that the difference in the feature quantities is reduced.

14. A non-transitory computer readable medium including programmed instructions, wherein the instructions, when executed by a computer, cause the computer to perform:
acquiring a structure from a medical image;
setting one or more lines or planes that divide the structure into a plurality of regions;
calculating feature quantities related to a form of the structure for each of the regions; and
correcting the structure so that the difference in the feature quantities is reduced.
